(19) United States
(12) Patent Application Publication
(10) Pub. No.: US 2025/0375089 A1
(43) Pub. Date: Dec. 11, 2025

(54) SHOE CARE APPARATUS

(71) Applicant: Samsung Electronics Co., Ltd., Suwon-si (KR)

(72) Inventors: Jinyounggeul OH, Suwon-si (KR); Minjung JO, Suwon-si (KR)

(21) Appl. No.: 19/301,446

(22) Filed: Aug. 15, 2025

Related U.S. Application Data
(63) Continuation of application No. PCT/KR2023/021846, filed on Dec. 28, 2023.

(30) Foreign Application Priority Data
Mar. 15, 2023 (KR) 10-2023-0034158

(51) Int. Cl. A47L 23/20; A47L 23/18

(52) U.S. Cl. CPC A47L 23/205; A47L 23/18; A47L 2601/04

(57) ABSTRACT

A shoe care apparatus is provided. The shoe care apparatus includes a main body, a chamber provided in the main body to accommodate a shoe, an air supply port configured to supply air to the chamber, a support member configured to communicate with the air supply port and protruding from an inner surface of the chamber, and a shoe support device detachably provided on the support member, wherein the shoe support device is configured to partition the chamber into a first space and a second space located below the first space.

### CROSS-REFERENCE TO RELATED APPLICATION(S)

This application is a continuation application, claiming priority under 35 U.S.C. § 365(c), of an International application No. PCT/KR2023/021846, filed on Dec. 28, 2023, which is based on and claims the benefit of a Korean patent application number 10-2023-0034158, filed on Mar. 15, 2023, in the Korean Intellectual Property Office, the disclosure of which is incorporated by reference herein in its entirety.

### BACKGROUND

### 1. Field

The disclosure relates to a shoe care apparatus. More particularly, the disclosure relates to a shoe support device and a shoe care apparatus including the same.

### 2. Description of Related Art

A shoe care apparatus is a device for caring for shoes, such as drying the shoes, keeping them clean, and removing odors from the shoes.

Generally, a shoe care apparatus includes a main body forming the outer appearance, and a door is provided on the front of the main body to be openable and closable. A chamber forming the inner space is fixed inside the main body, and a duct is provided between the main body and the inner chamber to serve as a passage for air circulation.

Inside the chamber, a shoe support device for holding shoes is provided. The shoe support device is installed to be connected to the duct to induce air into the interior and allow the introduced air to enter the inside of the shoes to remove moisture and odor from the shoes.

The shoe support device has a detachable structure that allows the user to mount the shoes thereon, and when fully assembled, it is configured to be connected to the duct so that air may be guided into the shoes.

However, such a shoe support device occupies a large amount of chamber space since shoes are mounted in an inclined state. That is, even when small-sized shoes are mounted and much space remains in the chamber, additional shoes may not be mounted, leading to inefficiency.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a shoe care apparatus having an improved shoe support device that may make use of the chamber space.

Another aspect of the disclosure is to provide a shoe care apparatus having an improved shoe support device that allows a user to selectively care for a larger number of shoes.

Another aspect of the disclosure is to provide a shoe care apparatus capable of enhancing user satisfaction by expanding usability.

Additional aspects will be set forth in part in the description which follows and, in part, will be apparent from the description, or may be learned by practice of the presented embodiments.

In accordance with an aspect of the disclosure, a shoe care apparatus is provided. The shoe care apparatus includes a main body, a chamber provided in the main body to accommodate a shoe, an air supply port configured to supply air to the chamber, a support member configured to communicate with the air supply port and protruding from an inner surface of the chamber, and a shoe support device detachably provided on the support member, wherein the shoe support device is configured to partition the chamber into a first space and a second space located below the first space.

In accordance with another aspect of the disclosure, a shoe care apparatus is provided. The shoe care apparatus includes a main body, a plurality of chambers provided in the main body to accommodate shoe, an air supply port configured to supply air to each of the plurality of chambers, a support member protruding from an inner surface of the chamber, the support member configured to communicate with the air supply port to receive air from the air supply port, and a shoe support device detachably coupled to the support member, wherein the shoe support device is configured to divide the chamber into a first space and a second space located below the first space, and includes a first discharge part configured to supply air to the first space and a second discharge part configured to supply air to the second space.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a perspective view showing a shoe care apparatus according to an embodiment of the disclosure;

FIG. 2 is a view showing a state in which a door of the shoe care apparatus shown in FIG. 1 is opened according to an embodiment of the disclosure;

FIG. 3 is a sectional view taken along line A-A′ of FIG. 1, showing a cross-sectional view of a shoe care apparatus according to an embodiment of the disclosure;

FIG. 4 is a view showing a state in which the shoe support device shown in FIG. 3 is mounted to a chamber according to an embodiment of the disclosure;

FIG. 5 is a perspective view showing the shoe support device shown in FIG. 4 according to an embodiment of the disclosure;

FIG. 6 is a partial cross-sectional view taken along line B-B′ of FIG. 5, showing a shoe support device according to an embodiment of the disclosure;

FIGS. 7 and 8 are views showing a state in which the shoe support device is mounted to a support member according to various embodiments of the disclosure;

FIG. 9 is an enlarged view of part C in FIG. 7, showing a positioning groove provided in the support member according to an embodiment of the disclosure;

FIG. 10 is a view showing the bottom surface of a shoe support device according to an embodiment of the disclosure;

FIG. 11 is an enlarged view of part D of FIG. 10, showing a positioning protrusion of a shoe support device according to an embodiment of the disclosure; and

FIG. 12 is a cross-sectional view showing a first discharge part of a shoe support device according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the disclosure, a phrase such as “A or B,” “at least one of A and B,” “at least one of A or B,” “A, B or C,” “at least one of A, B and C,” and “at least one of A, B, or C” may include any one of the items listed together in the corresponding phrase of the phrases, or any possible combination thereof.

The term “and/or” includes combinations of one or all of a plurality of associated listed items.

As used herein, such terms as “1^{st}” and “2nd,” or “first” and “second” may be used to simply distinguish a corresponding component from another, and does not limit the components in other aspect (for example, importance or order).

When one (e.g., a first) element is referred to as being “coupled” or “connected” to another (e.g., a second) element with or without the term “functionally” or “communicatively,” it means that the one element is connected to the other element directly, wirelessly, or via a third element.

It will be understood that the terms “include,” “comprise” and/or “have” when used in this specification, specify the presence of stated features, integers, steps, operations, elements, and/or components, but do not preclude the presence or addition of one or more other features, integers, steps, operations, elements, components, and/or groups thereof.

It is to be understood that if a certain component is referred to as being “coupled with,” “coupled to,” “supported on” or “in contact with” another component, it means that the component may be coupled with the other component directly or indirectly via a third component.

Throughout the specification, when a member is referred to as being “on” another member, the member is in contact with another member or yet another member is interposed between the two members.

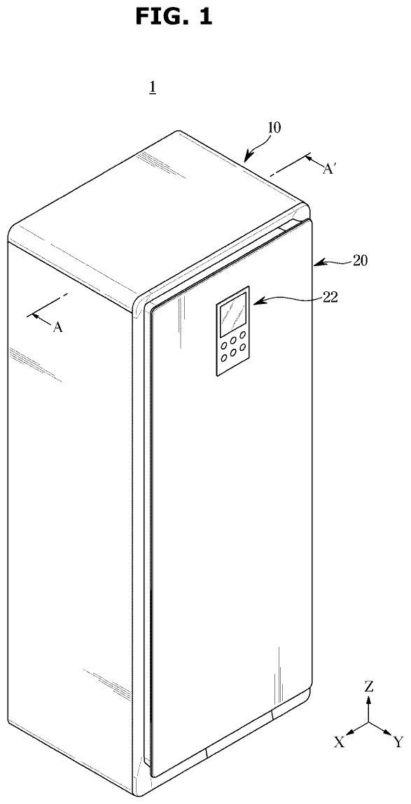

Also, in this specification, the terms “front,” “rear,” “upper,” “lower,” “right,” and “left” are defined based on the directions illustrate in FIG. 1, but the terms may not restrict the shape and position of the respective components.

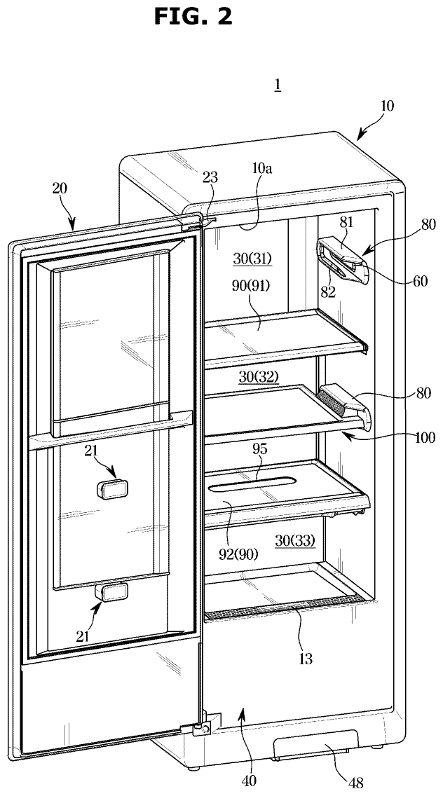

Specifically, referring to FIGS. 1 and 2, when a door of a shoe care apparatus is opened, the direction in which the inner surface is visible is defined as the front, and based on that, the rear, left, right, top, and bottom are defined accordingly.

Hereinafter, embodiments of the disclosure will be described in detail with reference to the accompanying drawings.

A shoe care apparatus may include various devices for dehumidifying a space, such as a clothing care device or a shoe care device. However, for convenience of explanation, the following description will be based on a shoe care apparatus.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

Hereinafter, embodiments according to the disclosure will be described in detail with reference to the accompanying drawings.

FIG. 1 is a perspective view showing a shoe care apparatus according to an embodiment of the disclosure.

FIG. 2 is a view showing a state in which a door of the shoe care apparatus shown in FIG. 1 is opened according to an embodiment of the disclosure.

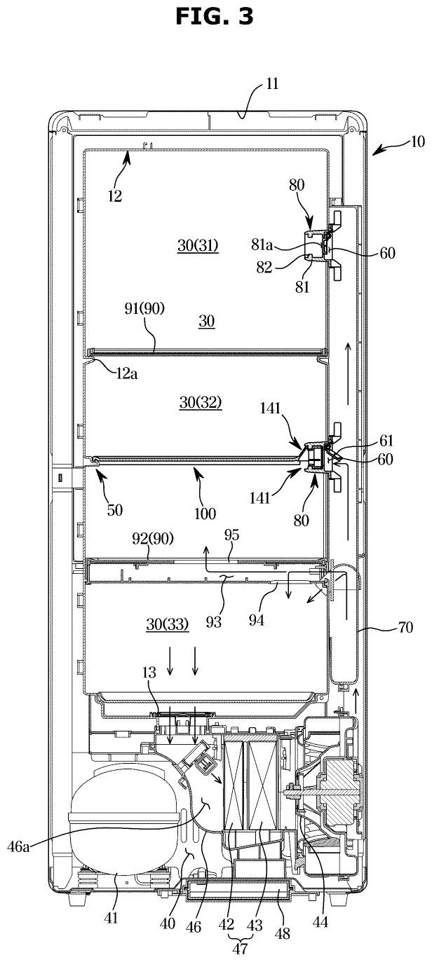

FIG. 3 is a sectional view taken along line A-A′ of FIG. 1, showing the shoe care apparatus according to an embodiment of the disclosure.

Referring to FIGS. 1 to 3, a shoe care apparatus 1 may include a main body 10 forming the exterior and a door 20 rotatably coupled to the main body 10.

The main body 10 may be formed in a rectangular parallelepiped shape with an open front. An opening 10a may be formed at the open front of the main body 10. The door 20 may be rotatably coupled to the main body 10 and may be configured to open and close the front opening. The door 20 may be coupled to the main body 10 via a hinge 23 or the like.

The door 20 may include a hanging member 21 provided on a surface facing the inside of the shoe care chamber 30. The hanging member 21 may be provided in at least one unit. The hanging member 21 may be used to hang a handle 55 of the shoe support device 50, allowing the shoe support device 50 to be stored conveniently. However, the use of the hanging member 21 is not limited thereto and may be used to hang other components.

The door 20 may further include a display unit 22 provided on the front of the shoe care apparatus 1. The user may select a suitable care course for the type of shoes to be cared for via the display unit 22. Accordingly, the temperature and humidity of the shoe care chamber 30 may be controlled to reduce damage to the shoes.

The main body 10 may include an outer cabinet 11 and an inner cabinet 12 disposed inside the outer cabinet 11. The inner cabinet 12 may also be referred to as a cabinet 12.

The shoe care chamber 30 of the shoe care apparatus 1 may be referred to as the chamber 30. The chamber 30 may be configured to accommodate shoes and to form a space for receiving shoes. The chamber 30 may be divided by at least one plate 91, 92 provided in the inner cabinet 12. The chamber 30 may include a first chamber 30, 31 formed at the uppermost side by the first plate 91, a second chamber 30, 32 formed in the middle by the first and second plates 91 and 92 and a third chamber 30, 33 formed at the lowermost by the second plate 92. In the embodiment, two plates are shown and three chambers are provided, but the disclosure is not limited thereto. Hereinafter, the first chamber 30, 31, the second chamber 30, 32, and the third chamber 30, 33 may collectively be referred to as the chamber 30.

The shoe care apparatus 1 may include a heat exchanger (hereinafter referred to as a “heat pump”) for heating air supplied to the chamber 30 and dehumidifying air discharged from the chamber 30.

The shoe care apparatus 1 may include a machine room 40 in which components such as the heat exchanger 47 for dehumidifying or heating air inside the chamber 30 and the like may be provided. The machine room 40 may be disposed at a lower side of the chamber 30.

The shoe care apparatus 1 may include a shoe support device 100 provided inside the chamber 30 to support shoes. The shoe support device 100 may be detachably mounted from the chamber 30. The shoe support device 100 will be described below.

The chamber 30 may include a support member 80 configured to detachably support the shoe support device 100. The support member 80 may be located on the right side of the chamber 30. The support member 80 may be located on the sidewall of the chamber 30.

The shoe support device 100 may be detachably mounted to the support member 80. The shoe support device 100 may be configured to be mounted along the front-rear direction of the chamber 30. The detailed structure of the support member 80 will be described below.

A water collection tank 48 may be detachably installed at a lower portion of the main body 10. The water collection tank 48 may be disposed a lower portion of the machine room 40 to facilitate the treatment of condensate water resulting from the heat exchanger 47.

The machine room 40 may be provided at a lower side of the main body 10. The machine room 40 may be provided at a lower portion of the chamber 30. The heat exchanger 47 may be provided in the machine room 40. The heat exchanger 47 may be provided to dehumidify and heat air inside the chamber 30 as needed. The heat exchanger 47 may be provided to supply heated air into the chamber 30. The heat exchanger 47 may include an evaporator 42, a condenser 43, and a compressor 41, through which refrigerant circulates. The heat exchanger 47 may dehumidify and heat air. When a refrigerant evaporates in the evaporator 42 of the heat exchanger 47, the refrigerant absorbs latent heat from the surrounding air, thereby condensing and removing moisture from the air. When a refrigerant is condensed in the condenser 43 after passing through the compressor 41, the refrigerant releases latent heat toward the surrounding air, thereby heating the surrounding air. As the evaporator 42 and the condenser 43 perform a heat exchange function, air introduced into the machine room 40 by the blower fan 44 may sequentially pass through the evaporator 42 and the condenser 43 to be dehumidified and heated.

The shoe care apparatus 1 may include an air supply duct 70 that connects the chamber 30 and the machine room 40.

The blower fan 44 may be a centrifugal fan that draws in air along the axial direction and discharges air toward the air supply duct 70. However, the disclosure is not limited thereto.

The shoe care apparatus 1 may further include an exhaust port 13. The exhaust port 13 may be disposed at the lower portion of the chamber 30. The air used to dry the shoes in the chamber 30 may flow into a circulation duct 46 through the exhaust port 13. The exhaust port 13 may be configured to direct heated air into the circulation duct 46.

The heat exchanger 47 installed in the machine room 40 may further include the circulation duct 46 that connects the evaporator 42, the condenser 43, and the blower fan 44. The circulation duct 46 may be connected to the chamber 30, thereby forming a circulation flow path 46a between the chamber 30 and the circulation duct 46.

The circulation duct 46 may be connected to the air supply duct 70 and the exhaust port 13 of the chamber 30. One end of the circulation duct 46 may be connected to the air supply duct 70, and the other end of the circulation duct 46 may be connected to the exhaust port 13. Air introduced through the exhaust port 13 may be dehumidified, and then supplied back to the chamber 30 through the air supply duct 70 and the air supply port 60.

The shoe care apparatus 1 may further include a water tank (not shown), a steam generator (not shown), and a steam injection device (not shown). The water tank may be disposed at the lower portion of the chamber 30. The water from the water tank may be supplied to the steam generator and used to generate steam. The water tank may be detachably installed from the main body to facilitate water replenishment.

In addition, the steam generator configured to receive water from the water tank and generate steam may be provided in the machine room 40. The steam generator may be connected to the water tank to receive water and generate steam, and may include a steam supply pipe (not shown) for guiding the generated steam to the steam injection device (not shown).

The shoe care apparatus 1 may include one or more plates 90, 91, and 92 partitioning the inner cabinet 12. One of the one or more plates 90, 91, and 92 may be a duct plate 92. Referring to FIG. 3, the duct plate 92 may include an internal flow path 93. Heated air passing through the internal flow path 93 may be sprayed toward the shoes from an injection port 94 and a circular port 95 of the duct plate 92.

The shoe care apparatus 1 may include a support protrusion 12a. The support protrusion 12a may be configured to allow the plate 90 to be disposed within the chamber 30. The support protrusion 12a may be configured to support the plate 90 so that the plate 90 does not fall. The support protrusion 12a may be formed to protrude from the inner cabinet 12. The support protrusion 12a may be integrally formed to protrude inwardly from the inner cabinet 12. The support protrusions 12a may be formed to correspond to each other on both sidewalls of the inner cabinet 12.

The shoe care apparatus 1 may further include an air supply port 60. The air supply port 60 may be formed on a sidewall of the inner cabinet 12. The air supply port 60 may be configured to supply air to the chamber 30. The air supply port 60 is provided to supply heated air into the chamber 30 to dry the shoes.

The shoe care apparatus 1 may include a support member 80 configured to be in communication with the air supply port 60. The chamber 30 may be provided with a support member 80 that communicates with the air supply port 60. The support member 80 may be provided adjacent to the air supply port 60 of the chamber 30.

The support member 80 may be configured such that the shoe support device 100 is detachably supported. The support member 80 is configured such that the shoe support device 100 may be detachably coupled in the front-rear direction. The support member 80 may include a support bracket 81 fixed to the inner cabinet 12. The support bracket 81 may be provided with an opening 81a that may communicate with the air supply port 60. The opening 81a of the support bracket 81 is formed as a through-hole to allow connection between the chamber 30 and the air supply duct 70. The opening 81a of the support bracket 81 may be opened and closed by a supply door 61.

The support bracket 81 of the support member 80 may be formed to support at least a portion of the shoe support device 100 when the shoe support device 100 is mounted. The support bracket 81 may be formed to cover a connection part 120 of the shoe support device 100, which will be described below. The support bracket 81 may be formed with one side open so that the shoe support device 100 may be slidingly coupled.

The support member 80 may further include a coupling rib 82 configured to guide movement of the shoe support device 100 when the shoe support device 100 is being coupled or detached. The coupling rib 82 may be provided on the inner side of the support bracket 81. The coupling rib 82 may be formed to extend along the direction in which the shoe support device 100 is coupled or detached.

The shoe care apparatus 1 may include the shoe support device 100. The shoe support device 100 may be detachably mounted on the inner sidewall of the inner cabinet 12.

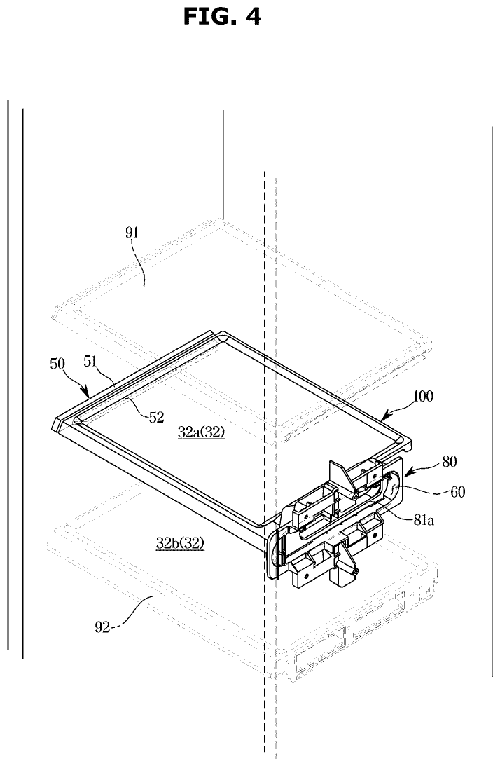

FIG. 4 is a view showing a state in which the shoe support device shown in FIG. 3 is mounted in the chamber according to an embodiment of the disclosure.

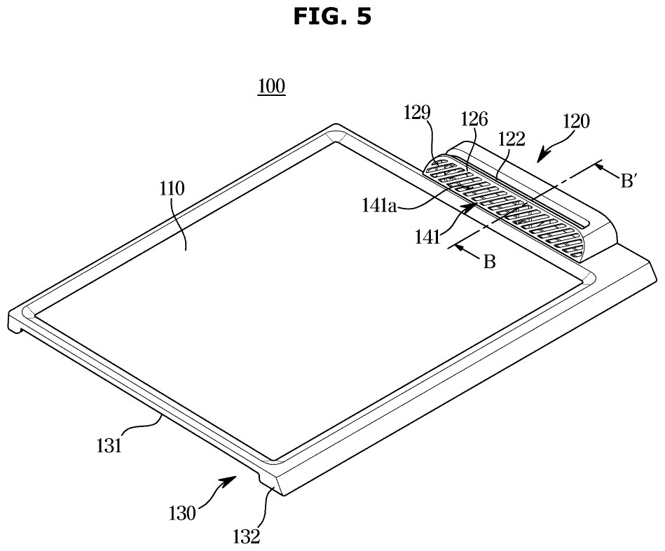

FIG. 5 is a perspective view showing the shoe support device illustrated in FIG. 4 according to an embodiment of the disclosure.

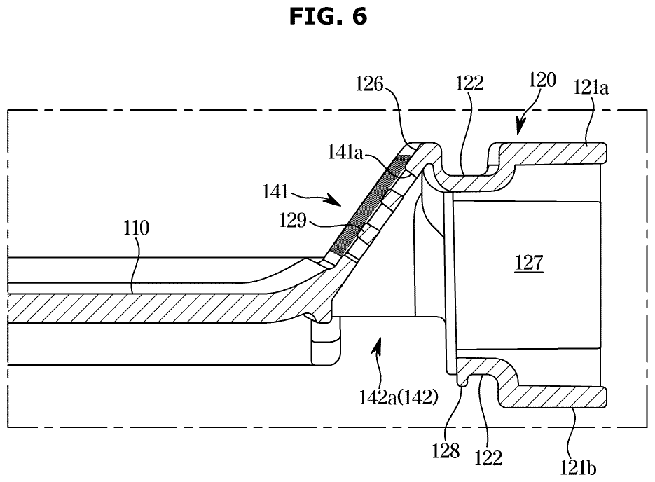

FIG. 6 is a sectional view taken along line B-B′ of FIG. 5 and is a partial cross-sectional view of the shoe support device according to an embodiment of the disclosure.

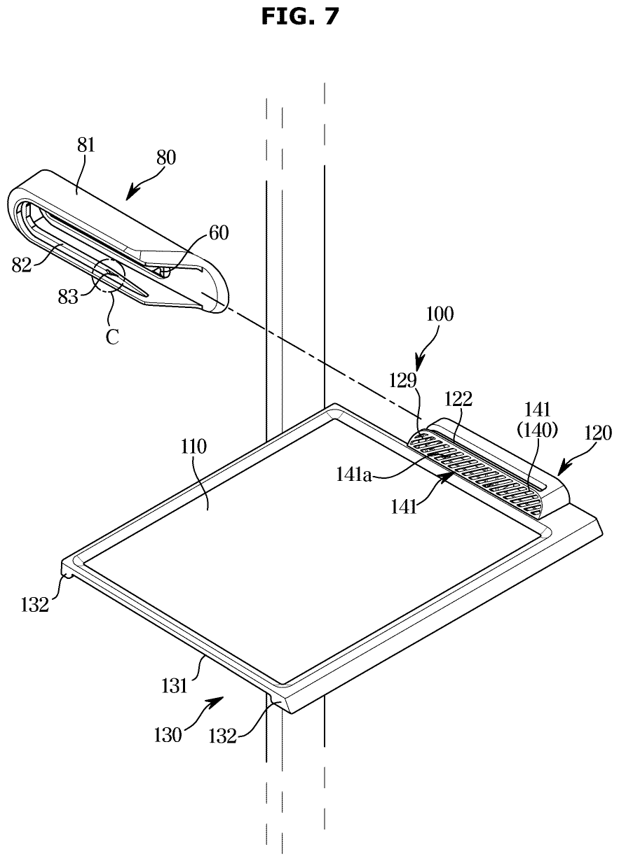

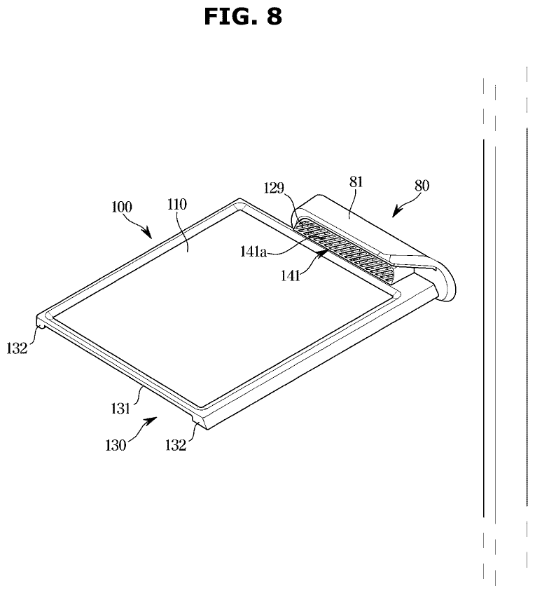

FIGS. 7 and 8 are views showing a state in which the shoe support device according to one embodiment is mounted to the support member according to various embodiments of the disclosure. Hereinafter, repeated descriptions of the above-mentioned contents will be omitted.

Referring to FIGS. 4 to 7, the shoe support device 100 may be detachably mounted to the chamber 30 of the shoe care apparatus 1. The shoe support device 100 may be detachably mounted to the support member 80 installed in the chamber 30.

The shoe support device 100 may be detachably mounted to each of the plurality of chambers 30 of the shoe care apparatus 1. The shoe support device 100 may be detachably mounted to the support member 80 provided in each of the plurality of chambers 30.

The shoe support device 100 may be configured to divide one chamber 30, 32 into a first space 32a and a second space 32b. For example, the shoe support device 100 may be mounted in the second chamber 30, 32. The shoe support device 100 may be configured to divide the second chamber 30, 32 into a first space 32a and a second space 32b located below the first space 32a. The first space 32a may be provided at an upper portion of the shoe support device 100. The second space 32b may be provided at a lower portion of the shoe support device 100. Using the shoe support device 100, one shoe may be placed in the first space 32a of the second chamber 30, 32, and another shoe may be placed in the second space 32b of the second chamber 30, 32, so that two shoes may be stored and cared for in the second chamber 30, 32, which has conventionally been configured to hold only one shoe. In the embodiment, the shoe support device 100 is illustrated as being mounted in the second chamber 30, 32, but embodiments of the disclosure are not limited thereto. For example, the shoe support device 100 may be mounted in both the first chamber 30, 31 and the second chamber 30, 32 according to user selection, thereby allowing four shoes to be cared for.

The shoe support device 100 may include a plate-shaped support body 110, a connection part 120 provided on one side of the support body 110 and configured to be coupled with the support member 80, and a coupling part 130 provided on the other side of the support body 110.

The support body 110 of the shoe support device 100 may be formed in a plate shape. The support body 110 may be formed in a quadrangular plate shape. A first space 32a may be formed by an upper surface of the support body 110. A shoe to be cared for in the first space 32a may be mounted on the upper surface of the support body 110. A second space 32b may be formed by a lower surface of the support body 110.

The connection part 120 of the shoe support device 100 may be provided at one end of the support body 110. The connection part 120 may be integrally formed to extend from the support body 110. The connection part 120 may be formed in a shape corresponding to the support member 80 of the chamber 30. The connection part 120 may include a first connection body 121a forming an upper surface and a second connection body 121b forming a lower surface. The first connection body 121a may be formed to extend from the upper surface of the support body 110, and the second connection body 121b may be formed to extend from the lower surface of the support body 110. The first connection body 121a and the second connection body 121b may be integrally formed with each other.

The connection part 120 may include a connection groove 122 for coupling with the support member 80. The connection groove 122 may be formed to be recessed in the outer surface of the connection part 120. The connection groove 122 may be formed to be recessed in the mounting direction of the shoe support device 100. The connection groove 122 may be formed to correspond to the coupling rib 82 of the support member 80. The connection groove 122 may be formed in the first connection body 121a and the second connection body 121b of the connection part 120. The connection grooves 122 formed in the first connection body 121a and the second connection body 121b may be slidingly coupled with the coupling rib 82 of the support member 80, so that the connection part 120 of the shoe support device 100 may be mounted in the chamber 30.

The connection part 120 may include a connection flow path 127 communicating with the air supply port 60 of the chamber 30 to allow air to flow. An internal space defined by the first connection body 121a and the second connection body 121b may form the connection flow path 127 through which air may move. The connection flow path 127 may be formed inside the connection part 120. The connection flow path 127 may be connected to the air supply port 60 and the opening 81a of the support member 80. Through the air supply port 60, air may flow into the connection flow path 127 of the connection part 120.

The shoe support device 100 may include a first discharge part 141 configured to supply air, introduced through the air supply port 60, to the first space 32a of the chamber 30. The shoe support device 100 may include a second discharge part 142 configured to supply air, introduced through the air supply port 60, to the second space 32b of the chamber 30.

The first discharge part 141 of the shoe support device 100 may be provided at an upper portion of the connection part 120. The first discharge part 141 may be disposed in the first connection body 121a. The first discharge part 141 may be configured to supply air to the first space 32a of the chamber 30.

The second discharge part 142 of the shoe support device 100 may be provided at a lower portion of the connection part 120. The second discharge part 142 may be disposed in the second connection body 121b. The second discharge part 142 may be configured to supply air to the second space 32b of the chamber 30.

The first discharge part 141 of the shoe support device 100 may include a first discharge hole 141a formed to pass through the connection part 120 to communicate between the first space 32a of the chamber 30 and the connection flow path 127. The first discharge hole 141a may be provided in the first connection body 121a of the connection part 120.

The connection part 120 of the shoe support device 100 may further include a connection surface 126 connecting the support body 110 and the first connection body 121a. The connection surface 126 may form a front surface of the first connection body 121a. The connection surface 126 may be formed in an inclined shape. The connection surface 126 may be configured to connect the support body 110 and the first connection body 121a.

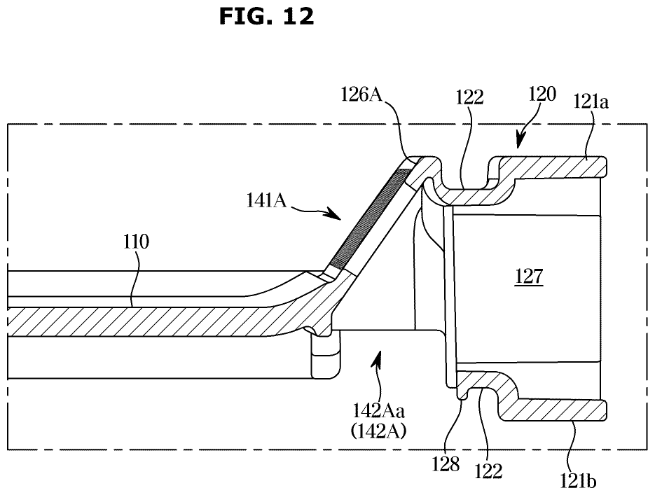

The first discharge part 141 may be provided on the connection surface 126. The first discharge hole 141a may be provided on the connection surface 126. The first discharge part 141 may further include a plurality of ribs 129 provided in the first discharge hole 141a. The plurality of ribs 129 of the first discharge part 141 may prevent foreign substances from entering the inside of the air supply duct 70. The first discharge hole 141a may be provided in plural on the connection surface 126, with at least one unit thereof. The first discharge hole 141a may be formed in plural. The air supplied through the plurality of first discharge holes 141a formed on the connection surface 126 may care for the shoes mounted in the first space 32a of the chamber 30. Meanwhile, the first discharge hole 140 may include a single hole 141A formed by opening at least a portion of a connection surface 126A (see FIG. 12).

The second discharge part 142 may be provided on the lower surface of the connection part 120. The second discharge hole 142a may be provided in the second connection body 121b of the connection part 120. The second discharge hole 142a may include a single hole. The air supplied through the second discharge hole 142a may care for the shoe mounted in the second space 32b of the chamber 30.

The coupling part 130 of the shoe support device 100 may be provided on the other side of the support body 110. The coupling part 130 may be configured to allow the shoe support device 100 to be mounted in the chamber 30.

The chamber 30 of the shoe support device 100 may further include a support part 50 configured to support the shoe support device 100 (see FIG. 4). The support part 50 may be provided in the inner cabinet 12 of the shoe care apparatus 1. The support part 50 may include a first support 51 extending from the chamber 30, and a second support 52 protruding from the first support 51 and formed with a short length.

The coupling part 130 of the shoe support device 100 may be configured to correspond to the support part 50 of the chamber 30. The coupling part 130 will be described below.

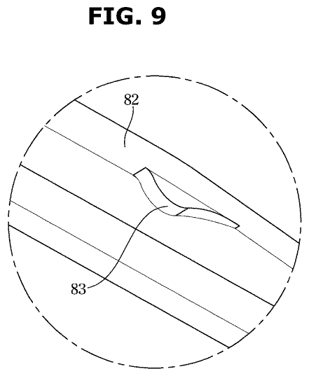

FIG. 9 is an enlarged view of portion C of FIG. 7, showing a positioning groove provided in the support member according to an embodiment of the disclosure.

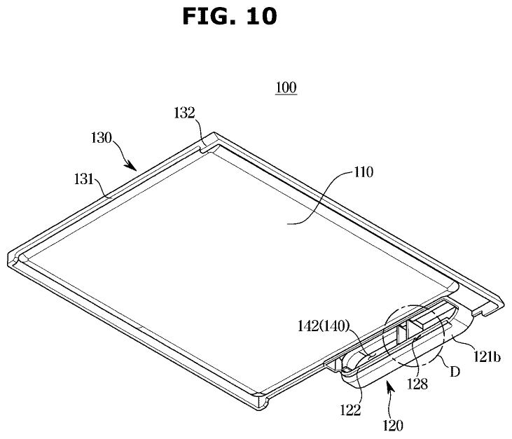

FIG. 10 is a view showing the bottom surface of the shoe support device according to an embodiment of the disclosure.

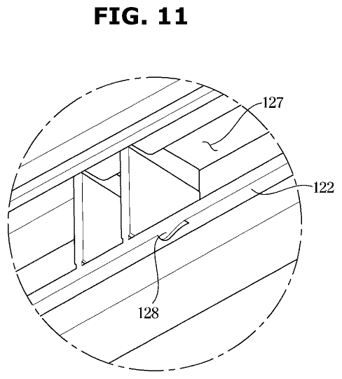

FIG. 11 is an enlarged view of portion D of FIG. 10, showing a positioning protrusion of the shoe support device according to an embodiment of the disclosure.

FIG. 12 is a cross-sectional view showing a first discharge part of a shoe support device according to an embodiment of the disclosure. Hereinafter, redundant descriptions overlapping with the above will be omitted.

Referring to FIGS. 9 to 11, the shoe support device 100 may include a support body 110, a connection part 120 provided at one end of the support body 110, and a coupling part 130 provided at the other end of the support body 110.

The coupling part 130 of the shoe support device 100 may be provided at the other end of the support body 110. The coupling part 130 may be configured to correspond to the support part 50 of the chamber 30. The coupling part 130 may include a coupling support portion 131 configured to be supported by the second support 52 of the support part 50. The coupling support portion 131 may be configured to correspond to the second support 52. The coupling part 130 may include a detachment prevention portion 132 configured to prevent the coupling support portion 131 from being separated from the support part 50. The detachment prevention portions 132 may be located at both ends of the coupling support portion 131. The detachment prevention portion 132 may be formed in a stepped manner from the coupling support portion 131. The detachment prevention portion 132 may be inserted into a groove formed by a difference in length between the first support 51 and the second support 52, and may be configured to prevent the shoe support device 100 from being separated from the support part 50.

The connection part 120 of the shoe support device 100 may further include a protrusion 128 to confirm the coupling position when coupled with the support member 80. The protrusion 128 of the connection part 120 may be formed to protrude from the second connection body 121b. The protrusion 128 may be formed to protrude from the connection groove 122 formed in the second connection body 121b.

In the support member 80 to which the connection part 120 of the shoe support device 100 is coupled, a groove 83 corresponding to the protrusion 128 may be formed. The groove 83 may be formed in the coupling rib 82 to which the connection groove 122 of the support member 80 is coupled.

The connection groove 122 of the connection part 120 may be inserted into the coupling rib 82 of the support member 80 and slidingly coupled. The protrusion 128 formed in the connection groove 122 may be seated in the groove 83 formed in the coupling rib 82, so that the connection part 120 may be coupled to the support member 80 in an accurate position. By coupling the connection part 120 and the support member 80 in an accurate position, the opening 81a of the support member 80 may be in communication with the air supply port 60, and the air supplied through the air supply port 60 may be smoothly delivered to the first space 32a and the second space 32b of the chamber 30 through the connection flow path 127 of the connection part 120.

A shoe care apparatus 1 according to an embodiment may include a main body 10, a chamber 30 provided in the main body for accommodating shoes, an air supply port 60 configured to supply air to the chamber 30, and a support member 80 configured to communicate with the air supply port 60 to receive air therefrom, the support member 80 being protruded from an inner surface of the chamber 30, and a shoe support device 100 detachably provided on the support member 80, wherein the shoe support device 100 is configured to divide the chamber 30, 32 into a first space 32a and a second space 32b located below the first space 32a. According to the disclosure, a shoe support device having an improved structure divides a single chamber space for storing shoes into an upper space and a lower space, thereby allowing two pairs of shoes to be stored. Accordingly, shoes with relatively less contamination may be lightly cared for on a daily basis, which may enhance consumer satisfaction.

The shoe support device 100 includes a first discharge part 141 configured to supply air to the first space 32a, and a second discharge part 142 configured to supply air to the second space 32b. The chamber is provided as a plurality of chambers, the air supply port and the support member are provided in each of the plurality of chambers, and the shoe support device is configured to vertically divide one of the plurality of chambers. Accordingly, a single chamber space may be divided into upper and lower sections, enabling two pairs of shoes to be cared for.

The shoe support device 100 includes a support body 110 having a plate shape, a connection part 120 provided on one side of the support body 110 and configured to be coupled with the support member 80, and a coupling part 130 provided on the other side of the support body 110 and allowing the support body 110 to be coupled to a support part 50 on the inner wall of the chamber 30. The shoe support device further includes a connection flow path 127 communicating with the air supply port 60 to allow air to move through the connection part 120.

The first discharge part 141 includes a first discharge hole 141a provided on the outer surface of the connection part 120 to communicate between the first space 32a and the connection flow path 127. The second discharge part 142 includes a second discharge hole 142a provided on the outer surface of the connection part 120 to communicate between the second space 32b and the connection flow path 127. The first discharge hole 141a is disposed on the upper surface of the connection part 120, and the second discharge hole 142a is disposed on the lower surface of the connection part 120. The first discharge hole 141a and the second discharge hole 142a are formed as at least one unit thereof. Accordingly, a single chamber space may be divided into an upper space and a lower space to accommodate two pairs of shoes, and shoes with relatively less contamination may be lightly cared for on a daily basis, thereby increasing consumer satisfaction.

The connection part 120 includes a connection surface 126 formed to be connected to the support body 110, and the connection surface 126 is formed in an inclined shape. The first discharge part 141 is disposed on the connection surface 126.

The connection part 120 includes a protrusion 128 formed to fix the position when coupled with the support member 80, and the support member 80 includes a groove 83 corresponding to the protrusion 128. Accordingly, the shoe support device may be positioned at a correct position on the support member of the chamber, so that the air supplied from the air supply duct may be fully delivered.

The coupling part 130 further includes a detachment prevention portion 132 formed in a stepped shape to prevent the coupling part 130 from being separated from the support part 50. Accordingly, sagging of the shoe support device that may occur due to the weight of the shoes may be prevented, and separation of the shoe support device that may occur when removing the shoes may also be prevented.

A shoe care apparatus according to an embodiment includes: a main body 10; a chamber 30 provided in the main body 10 and configured to accommodate shoes; an air supply port 60 configured to supply air to the chamber 30; a support member 80 configured to communicate with the air supply port 60 to receive air from the air supply port 60, the support member 80 protruding from an inner surface of the chamber 30; and a shoe support device 100 detachably coupled to the support member 80. The shoe support device 100 is configured to divide the chamber 30 into a first space 32a and a second space 32b located below the first space 32a, and includes a first discharge part 141 configured to supply air to the first space 32a, and a second discharge part 142 configured to supply air to the second space 32b. According to the disclosure, a shoe support device having an improved structure divides a single chamber space for storing shoes into an upper space and a lower space, thereby allowing two pairs of shoes to be stored. Accordingly, shoes with relatively less contamination may be lightly cared for on a daily basis, which may increase consumer satisfaction.

The shoe support device 100 includes: a support body 110 having a plate-shape; a connection part 120 provided on one side of the support body 110 and coupled to the support member 80; a connection flow path 127 configured to communicate with the air supply port 60 so that air may flow through the connection part 120; and a coupling part 130 provided on the other side of the support body 110 and allowing the support body 110 to be coupled to a support part 50 on an inner wall of the chamber 30. The first discharge part 141 includes a first discharge hole 141a provided on an upper surface of the connection part 120 to communicate between the first space 32a and the connection flow path 127. The second discharge part 142 includes a second discharge hole 142a provided on a lower surface of the connection part 120 to communicate between the second space 32b and the connection flow path 127. The first discharge hole 141a and the second discharge hole 142a are formed in plural, with at least one unit thereof. Accordingly, a single chamber space may be divided into an upper space and a lower space, allowing two pairs of shoes to be stored.

The connection part 120 includes a protrusion 128 formed to protrude to fix the position when coupled with the support member 80, and the support member 80 includes a groove 83 corresponding to the protrusion 128. Accordingly, the shoe support device may be positioned at an accurate location on the support member of the chamber, so that the air supplied from the air supply duct may be fully delivered.

According to an example, a single chamber space can be divided into an upper space and a lower space through a shoe support device having an improved structure, allowing two pairs of shoes to be stored, and shoes with relatively less contamination can be lightly cared for on a daily basis, thereby increasing consumer satisfaction.

According to an example, the shoe support device can be positioned at an accurate location on the support member of the chamber, so that the air supplied from the air supply duct can be fully delivered into the chamber.

According to an example, sagging of the shoe support device caused by the weight of the shoes can be prevented, and separation of the shoe support device that may occur when removing shoes can also be prevented.

The effects of the disclosure are not limited to the effects described above, and other effects that are not described will be clearly understood by those skilled in the art from the above detailed description.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A shoe care apparatus comprising:
a main body;
a chamber provided in the main body to accommodate a shoe;
an air supply port configured to supply air to the chamber;
a support member configured to communicate with the air supply port and protruding from an inner surface of the chamber; and
a shoe support device detachably provided on the support member,
wherein the shoe support device is configured to partition the chamber into a first space and a second space located below the first space.

2. The shoe care apparatus of claim 1, wherein the shoe support device comprises:
a first discharge part configured to supply air to the first space; and
a second discharge part configured to supply air to the second space.

3. The shoe care apparatus of claim 1,
wherein the chamber is a plurality of chambers,
wherein the air supply port and the support member are provided in each of the plurality of chambers, and
wherein the shoe support device is configured to partition one of the plurality of chambers vertically.

4. The shoe care apparatus of claim 2, wherein the shoe support device comprises:
a support body having a plate-shape;
a connection part provided on one side of the support body and configured to be coupled to the support member; and
a coupling part provided on the other side of the support body and configured to allow the support body to be coupled to a support part on an inner wall of the chamber.

5. The shoe care apparatus of claim 4, wherein the shoe support device further comprises:
a connection flow path configured to communicate with the air supply port to allow air to flow through the connection part.

6. The shoe care apparatus of claim 5, wherein the first discharge part comprises:
a first discharge hole provided on an outer surface of the connection part to communicate the first space with the connection flow path.

7. The shoe care apparatus of claim 6, wherein the second discharge part comprises:
a second discharge hole provided on an outer surface of the connection part to communicate the second space with the connection flow path.

8. The shoe care apparatus of claim 7, wherein the first discharge hole is disposed on an upper surface of the connection part.

9. The shoe care apparatus of claim 7, wherein the second discharge hole is disposed on a lower surface of the connection part.

10. The shoe care apparatus of claim 7, wherein the first discharge hole and the second discharge hole are formed in plurality.

11. The shoe care apparatus of claim 7,
wherein the connection part comprises:
a connection surface formed to connect with the support body, and
wherein the connection surface is formed to be inclined.

12. The shoe care apparatus of claim 11, wherein the first discharge part is disposed on the connection surface.

13. The shoe care apparatus of claim 11,
wherein the connection part comprises a protrusion formed to protrude and configured to fix a position when coupled with the support member, and
wherein the support member comprises a groove corresponding to the protrusion.

14. The shoe care apparatus of claim 4, wherein the coupling part further comprises:
a detachment prevention part formed in a stepped shape to prevent separation from the support part.
